(19) United States
(12) Patent Application Publication
(10) Pub. No.: US 2004/0016120 A1
(43) Pub. Date: Jan. 29, 2004

(54) Method and resulting device for fabricating electret materials on bulk substrates

(75) Inventors: Justin Boland, Pasadena, CA (US); Yu-Chong Tai, Pasadena, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: California Institute of Technology, Pasadena, CA

(21) Appl. No.: 10/455,226

(22) Filed: Jun. 4, 2003

Related U.S. Application Data
(60) Provisional application No. 60/387,181, filed on Jun. 7, 2002.
(60) Provisional application No. 60/388,875, filed on Jun. 13, 2002.

(51) Int. Cl. H01B 19/00

(52) U.S. Cl. 29/886

(57) ABSTRACT

An electret device. The device has a thickness of substrate material having a contact region. An electrically floating conducting region is formed overlying the thickness of substrate material. The floating conducting region is free from physical contact with the contact region. A protective layer is formed overlying the floating conductive layer. The protective layer has a surface region and seals the floating conducting region. The thickness of substrate material, floating conducting region, and protective layer form a sandwiched structure having a charge density of at least 1×10−4 Coulombs/m2 and a peak to peak charge uniformity of 5% and less.

### CROSS-REFERENCES TO RELATED APPLICATIONS

This present application claims priority to U.S. Provisional Patent Applications Nos. 60/387,181 (CIT No. 3703-P) filed Jun. 7, 2002 in the name of Boland, Justin and 60/388,875 (CIT No. 3706-P) filed Jun. 13, 2002 in the names of Boland, Justin and Tai, Yu-Chong, commonly owned, and hereby incorporated by reference for all purposes.

### STATEMENT AS TO RIGHTS TO INVENTIONS MADE UNDER FEDERALLY SPONSORED RESEARCH OR DEVELOPMENT

This work was partially supported by DARPA under Award Number DAAH01-01-R002 and by the Engineering Research Centers Program of the National Science Foundation under Award Number EEC-9402726

### BACKGROUND OF THE INVENTION

The present invention generally relates to fabricating one or more films of materials. More particularly, the invention provides a method and device for fabricating an electret device having improved electrical properties for generation of electrical power. Merely by way of example, the electret device has been fabricated using a patterning process including micromachining processes. But it would be recognized that other processes such as molding, casting, laser ablation, direct printing, etc. can also be used.

Electromagnetic generators have been used to supply power to a variety of applications. Extremely large power generators exist, such as those providing power using movement of water from large rivers that have been controlled by dams. As merely an example, Hoover Dam produces electricity for Los Angeles, Calif., United States of America. Alternatively, electromagnetic generators can be small to supply power to operate certain electronic functions on automobiles, home appliances, and personal appliances. Other types of generators also exist.

As merely an example, one type of electromagnetic generator is a direct current (“DC”) generator. Often times, the DC generator uses a rotating member that converts mechanical kinetic energy into electrical energy. Such conversion is provided by a rotating member called an armature, which carries conductors. The rotating member is within a magnetic field. To generate power, mechanical force is applied to the armature, which rotates within the magnetic field. Here, the armature turns about an axis which extends along the magnetic field. The rotation or twist of the armature within the field generates electric energy including voltage and current. The voltage and current are delivered through external load circuitry. Power generation from electromagnetic generators comes from what we understand as electromagnetic forces. Further details of the theory and operation of the electromagnetic generator can be found in The Bureau of Naval Personal, BASIC ELECTRICITY, Second Revised and Enlarged Edition, Dover Publications, Inc., New York (1969), among other sources.

Although highly effective for certain applications, electromagnetic generators have limitations as they become smaller and smaller. As merely an example, electromagnetic generators have been ineffective for providing power for applications having a form factor of less than one cubic centimeter. Conventional electromagnetic generators often cannot provide enough power as the size of the armature becomes less than an inch to operate many modern electronic devices such as cell phones, personal digital assistants, pagers, pace makers, and the like.

As merely an example, one of the smallest known commercial electromagnetic generators are being used has been developed by Seiko 's Kinetic series watches of Seiko Corporation of America. The peak power output from these generators is less than 40 microwatts, and not sufficient for continuous operation of the watch hands. To emphasize the problems, Seiko must often use a backup system inside their watches as well as many power saving techniques to keep time. Functionality of the watch is sacrificed due to the lack of a sufficient power supply. Accordingly, modern electronic devices still rely upon power from chemical power sources such as batteries, which often have a fixed life, are difficult to charge, and cumbersome.

Accordingly, electret generators are proposed to meet the needs of an increasingly. These electret generators rely upon electromotive force that is purely electric, rather than electromagnetic force used by conventional electromagnetic generators. Electret generator theory and experiments have been reported by O. D. Jefimenko, IEEE Trans. Ind. Appl., Vol. IA-14, pp. 537-540, 1978 and by Y. Tada, IEEE Trans. Elect. Insul. ET-21, 1986, pp. 457-464. An electret generator with a radius of 45mm was studied by Y. Tada, Jpn. J. Appl. Phys., Vol. 31, Part 1, No. 3, 1992, pp. 846-851. Here, a maximum reported power output from an electret generator was 1.02 mW. Unfortunately, conventional electret generators still lack a capability of becoming smaller and more effective and have not seen any commercial use. These and other limitations are described in further detail throughout the present specification and more particularly below.

From the above, it is seen that improved techniques for power generation is highly desirable.

### BRIEF SUMMARY OF THE INVENTION

According to the present invention,-techniques for fabricating one or more films of materials are provided. More particularly, the invention provides a method and device for fabricating an electret device having improved electrical properties for generation of electrical power. Merely by way of example, the electret device has been fabricated using a patterning process including micromachining processes. But it would be recognized that other processes such as molding, casting, laser ablation, direct printing of metals, etc. can also be used. Here, the term electret can be defined as a piece of dielectric material exhibiting a quasi-permanent electrical charge. The term quasi-permanent means that the time constants characteristic for the decay of the charge are much longer than the time periods over which studies are performed with the electret. Alternatively, other definitions for electret can also be used, depending upon the embodiment without departing fro the spirit of the scope of the claims herein.

In a specific embodiment, the invention provides a method of fabricating an electret device. The method includes providing a thickness of electrically insulating substrate material having a contact region. The method also includes forming an electrically floating region with at least 10 times larger conductance than the substrate formed overlying the thickness of substrate material. The floating conducting region is free from physical contact with the contact region. The method also includes forming a protective layer formed overlying the floating conductive region. The protective layer has a surface region. The protective layer seals the floating conducting region. The thickness of substrate material, floating conducting region, and protective layer forms a sandwiched structure having an initial charge density of at least 1×10⁻⁴ Coulombs/m² and a peak to peak electric field non-uniformity of 5% and less as measured directly above the protective layer.

In an alternative specific embodiment, the invention provides an electret device. The device has a thickness of substrate material having a contact region. An electrically floating conducting region is formed overlying the thickness of substrate material. The floating conducting region is free from physical contact with the contact region. A protective layer is formed overlying the floating conductive region. The protective layer has a surface region and seals the floating conducting region. The thickness of substrate material, floating conducting region, and protective layer form a sandwiched structure having a apparent charge density of at least 1×10⁻⁴ Coulombs/m² and a peak to peak electric field non-uniformity of 5% and less as measured directly above the protective layer.

In yet a further alternative embodiment, the invention provides a method of fabricating an electret device. The method includes providing a thickness of substrate material having a contact region and forming an electrically floating conducting region formed overlying the thickness of substrate material. The floating conducting region is free from physical contact with the contact region. The method includes forming a protective layer formed overlying the floating conductive region. The protective layer has a surface region. The protective layer seals the floating conducting region. The thickness of substrate material, floating conducting region, and protective layer form a sandwiched structure has an initial charge density of at least 1×10⁻⁴ Coulombs/m² and a peak to peak charge uniformity of 5% and less. The floating conductive layer interacts with charged particles to facilitate a uniform spatial distribution of charge along the electrically floating conducting region.

Numerous benefits are achieved using the present invention over conventional techniques. The invention can be implemented using conventional process technology. In other embodiments, the invention can be provide a micromachined electret structure, which can be used for a variety of applications. Preferably, the invention provides a highly uniform electret material, which is much better than conventional techniques. Electric field uniformity can be less than 5% or even 1% peak to peak in certain embodiments. Micromachining also allows for smaller design sizes, which can be mass produced. Depending upon the embodiment, one or more of these benefits may be achieved. These and other benefits are described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIGS. 1-7 are simplified diagrams of a method of forming an electret material according to an embodiment of the present invention;

FIGS. 8-14 are simplified diagrams of an alternative method of forming an electret material according to an alternative embodiment of the present invention;

FIGS. 15-21 are simplified diagrams of still an alternative method of forming an electret material according to an alternative embodiment of the present invention;

FIG. 22 is a simplified diagram of a electret generator according to an embodiment of the present invention;

FIG. 23 is a simplified process flow for manufacturing an electret device according to an embodiment of the present invention;

FIG. 24 is a simplified diagram of a charge density distribution for the electret device according to an embodiment of the present invention;

FIG. 25 is a simplified diagram of an electret apparatus according to an embodiment of the present invention;

FIG. 26 is a plot of power against speed according to an embodiment of the present invention;

FIG. 27 is a top-view diagram of an element in an electret generator according to an embodiment of the present invention

### DESCRIPTION OF THE SPECIFIC EMBODIMENTS

According to the present invention, techniques for fabricating one or more films of materials are provided. More particularly, the invention provides a method and device for fabricating an electret device having improved electrical properties for generation of electrical power. Merely by way of example, the electret device has been fabricated using a patterning process including micromachining processes. But it would be recognized that other processes such as computer numeric controlled machining can also be used.

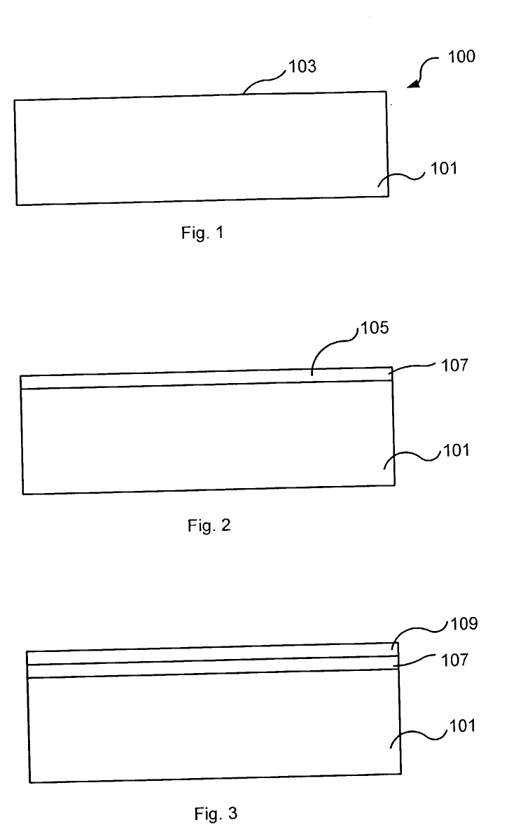

FIGS. 1-7 are simplified diagrams of a method of forming an electret material according to an embodiment of the present invention. These diagrams are merely examples, which should not unduly limit the scope of the claims herein. One of ordinary skill in the art would recognize many variations, modifications, and alternatives. As shown, the method begins by providing a substrate 101 to provide physical support. The substrate includes an overlying surface 103, which is preferably planar and smooth. The substrate is selected from a suitable material. The material can include conductive as well as non-conductive substrates. Additionally, the substrate may be a sacrificial layer meaning that it is removed after at least one additional process is completed. Preferably, the substrate comprises a silicon bearing material. Here, the substrate can be made of a silicon wafer. The silicon wafer can be doped or undoped. The silicon wafer can have a <100> orientation, but also can have other orientations. Depending upon the application, the substrate can also be conductive or insulating. The substrate can be made of a single homogeneous material, a graduated material, or multilayered material, depending upon the application.

Referring again to FIG. 2, the method includes forming a conductive layer 107 overlying the substrate. The conductive layer can be made of a suitable material such as aluminum, aluminum alloy, conductive polymer, gold, platinum, titanium, titanium alloy, tungsten, any combination of these and the like. The conductive layer can also be formed using multiple layers, which are stacked together to form a sandwiched structure. Aluminum is often evaporated overlying the surface of the substrate material. The conductive layer can form a portion of the contact region, which will be further described below.

The method includes forming an insulating layer 109 overlying the conductive layer, as shown in FIG. 3. The insulating material can be made of a suitable material such as silicon dioxide, air gaps, and polystyrene. Preferably, the insulating layer comprises a material such as fluoropolymer bearing material, which is a product sold by E. I. Dupont de Nemours and Company under the trademark Teflon®. The insulating material can be a single layer or multiple layers depending upon the application. If the insulating material is a Teflon material, it can be spin coated on the surface of the conductive layer. Other techniques can also exist to form the insulating layer, such as evaporation, chemical vapor deposition, dip coating, aerosol, bonding, molding, and other methods.

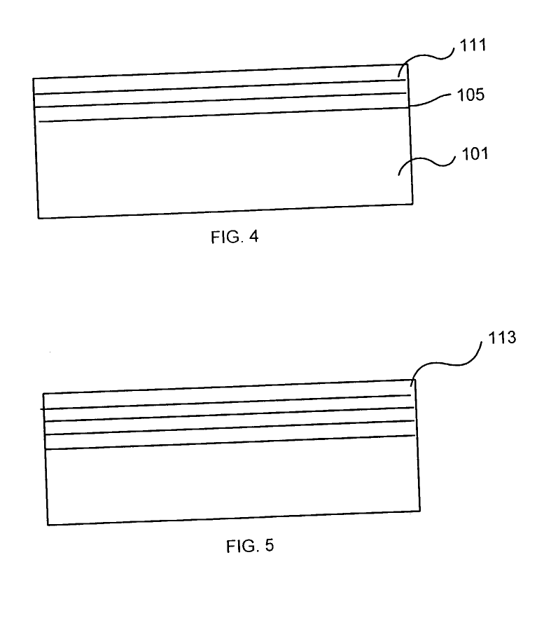

Next, the method forms an electrically floating conducting region 111 overlying the insulating layer, as shown in FIG. 4. The floating conducting region is free from physical contact with the contact region, which is on the conductive layer, via the insulating layer. The conducting region is made of a suitable material such as aluminum, gold, platinum, titanium, tungsten, alloys of such materials, or the like. Preferably, the floating conductive layer is aluminum that has a thickness of 5000 Angstroms and less. The aluminum is often evaporated, but can be formed in other ways, as well. Preferably, the method uses lithography to pattern the metal to ensure it is electrically floating. Alternatively, a physical mask or lift-off techniques can be used to selectively deposit an electrically floating region.

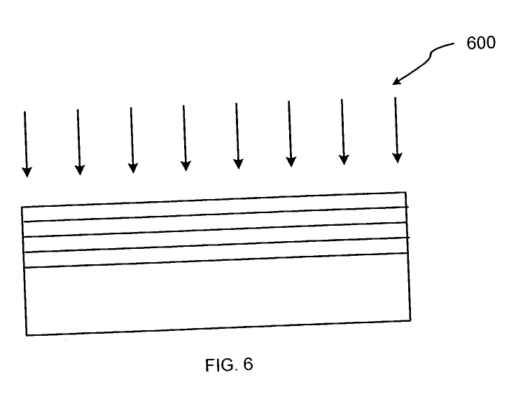

The method also includes forming a protective layer 113 overlying the floating conductive layer, as shown in FIG. 5. The protective layer has a surface region. The protective layer seals the floating conducting region. The protective layer can be made of a suitable material that seals the floating conductive layer. The protective layer can include sputtered oxide, a fluoropolymer, SOG (“Spin-On-Glass”), or other highly insulating materials. The protective layer can be a single layer or multiple layers, depending upon the application.

The method introduces electrical charge into the multilayered structure. That is, the thickness of substrate material, floating conducting region, and protective layer forms a sandwiched structure having an initial charge density of at least 1×10⁻⁴ Coulombs/m² and a peak to peak charge uniformity of 5% and less. Preferably, the charge density is provided by implantation 600 of a plurality of electrons, which are introduced through the protective layer, as illustrated by the simplified diagram of FIG. 6. The plurality of electrons are provided by a process selected from corona discharge, electron beam injection, ion-beam implantation, contact electrification, thermal charging, radiative and photo electret processes, and triboelectric charging. The floating conductive layer interacts with charged particles to facilitate a uniform spatial electric field as viewed from above the protective layer. Implanted charge can reside in the protective layer, the floating metal layer, and/or below the metal layer.

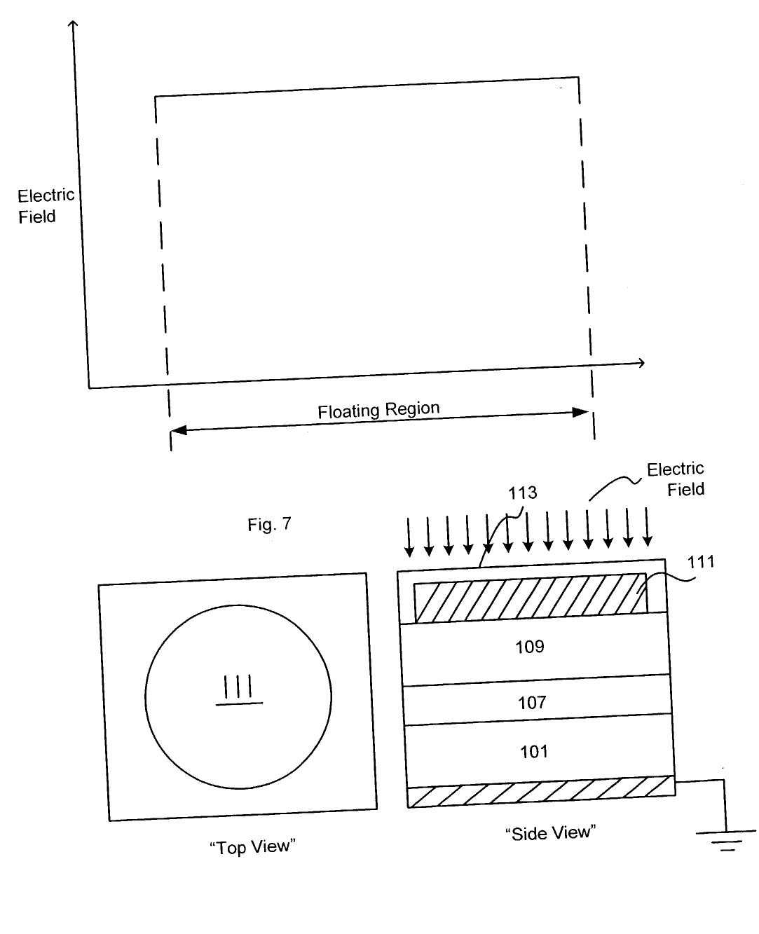

FIG. 7 is a simplified diagram of an electric field distribution 700 according to an embodiment of the present invention. This diagram is merely an illustration and should not unduly limit the scope of the claims herein. One of ordinary skill in the art would recognize many variations, alternatives, and modifications. As shown, the horizontal axis represents a spatial dimension and the vertical axis represents an electric field. The region over the floating region has a substantially uniform electric field in preferred embodiments. Although a metal layer has been used to form a region associated with charge accumulation, other types of surfaces can be used including dielectric and/or semiconductor regions that can trap charges for one reason or another. Additionally, the specific location of the electric charge can vary depending upon the embodiment. Certain charge can be within the metal layer or underlying the metal layer or overlying the metal layer or any combination of these without departing from the scope of the claims herein. Of course, one of ordinary skill in the art would recognize variations, alternatives, and modifications.

Although the above method is illustrated using a selected sequence of steps, it would be recognized that various modifications, alternatives, and variations exist. For example, some of the steps may be combined. Alternatively, some of the steps may be separated. Additional steps may be added before, within, or after any of the steps described above. The method can also provide the sequence of steps in a different manner without departing from the scope of the claims herein. Further ways of performing a method of fabricating an electret material can be found throughout the present specification and more particularly below.

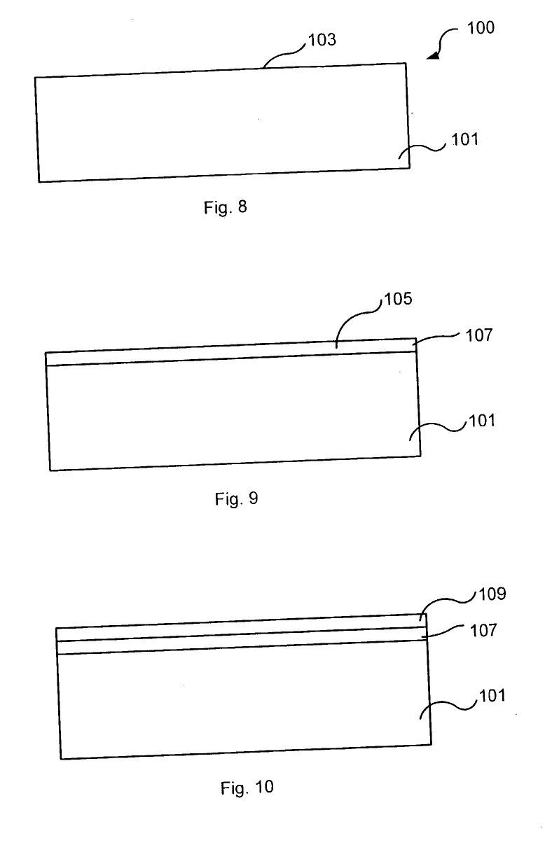

FIGS. 8-14 are simplified diagrams of a method of forming an electret material according to an alternative embodiment of the present invention. These diagrams are merely examples, which should not unduly limit the scope of the claims herein. One of ordinary skill in the art would recognize many variations, modifications, and alternatives. Like reference numerals are used in these diagrams as the others, but are not intended to be limiting the scope of the claims herein. As shown, the method begins by providing a substrate 101. The substrate includes an overlying surface 103, which is preferably planar and smooth. The substrate is selected from a suitable material. The material can include silicon as well as glass and quartz. Preferably, the substrate comprises a thermally grown silicon dioxide layer on a silicon bearing material. Here, the silicon bearing material can be made of a silicon wafer. The silicon wafer can be doped or undoped. The silicon wafer can have a <100> orientation, but also can have other orientations. Depending upon the application, the substrate can also be conductive or insulating. The substrate can be made of a single homogeneous material, a graduated material, or multilayered material, depending upon the application.

Preferably, the substrate includes a contact region 105 on the overlying surface. The contact region is free from insulating material. Other regions can include insulating materials. Such insulating materials include silicon dioxide, silicon nitride, any combination of these, and the like. Shape and size of the contact region are also selected. Of course, the particular shape and size depend highly upon the application.

Referring to FIG. 9, the method includes forming a conductive layer 107 overlying the substrate. The conductive layer can be made of a suitable material such as aluminum, aluminum alloy, conductive polymer, gold, platinum, titanium, titanium alloy, tungsten, any combination of these and the like. The conductive layer can also be formed using multiple layers, which are stacked together to form a sandwiched structure. Aluminum is often sputtered overlying the surface of the substrate material. The conductive layer can form a portion of the contact region, which will be further described below.

The method includes forming an insulating layer 109 overlying the conductive layer, as shown in FIG. 10. The insulating material can be made of a suitable material such as silicon dioxide, sputtered oxide, a plasma deposited fluoropolymer, SOG (“Spin-On-Glass”), polystyrene, and other deposited fluoropolymers. Preferably, the insulating layer comprises a material such as fluoropolymer bearing material, which is a product sold by E. I. Du pont de Nemours and Company under the trademark Teflon®. The insulating material can be a single layer or multiple layers depending upon the application.

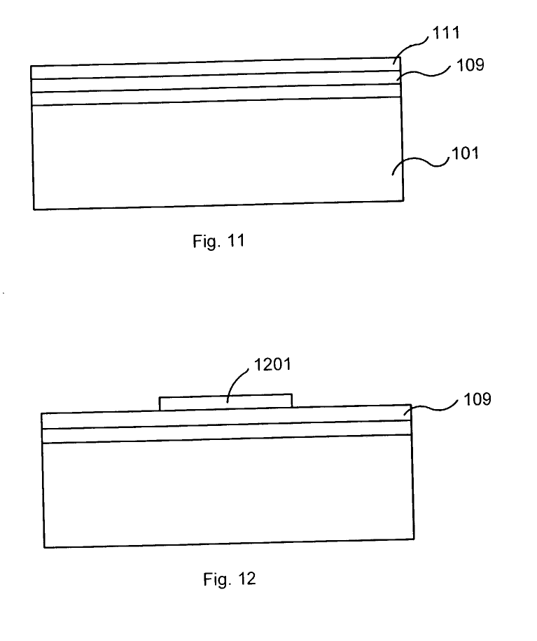

Next, the method forms an electrically floating conducting region 111 overlying the insulating layer, as shown in FIG. 11. The floating conducting region is free from physical contact with the contact region, which is on the conductive layer, via the insulating layer. The conducting region is made of a suitable material such as aluminum, gold, platinum, titanium, tungsten, alloys of such materials, or the like. Preferably, the floating conductive layer is aluminum that has a thickness of 5000 Angstroms and less.

Referring to FIG. 12, the method patterns the floating conductive layer 1201 using lithographic techniques. Preferably, method forms an overlying layer of photoresist material overlying the floating conductive layer. The photoresist material is patterned using conventional lithographic techniques to form a patterned mask structure. Etching techniques within openings of the patterned mask structure form the patterned floating conductive layer. The floating conductive layer includes a length that does not extend beyond the underlying insulating material, as also shown. Also shown are edges on the floating conductive layer, which sits on the insulating layer. That is, the insulating layer extends beyond the edges of the floating conductive layer.

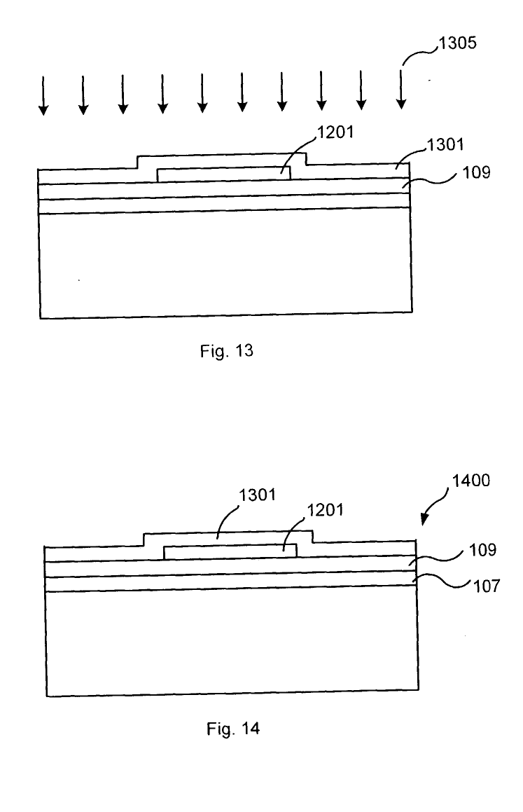

The method also includes forming a protective layer 1301 overlying the floating conductive layer, as shown in FIG. 13. The protective layer has a surface region. The protective layer seals the floating conducting region, including its edges. The protective layer can be made of a suitable material that seals the floating conductive layer. The protective layer can include sputtered oxide, a plasma deposited fluoropolymer, SOG (“Spin-On-Glass”), polystyrene, and other deposited fluoropolymers. The protective layer can be a single layer or multiple layers, depending upon the application. As shown, the patterned floating conductive layer 1201 is sealed and surrounding by insulating layer 1301 and underlying insulating layer 109. Depending upon the embodiment, there can also be alternative structures.

Charge 1305 particles implant into a sandwiched structure, as shown in FIG. 13. That is, the thickness of substrate material, floating conducting region, and protective layer forms the sandwiched structure having an initial charge density of at least 1×10⁻⁴ Coulombs/m² and a peak to peak charge uniformity of 5% and less. Preferably, the charge density is provided by implantation of a plurality of electrons, which are introduced through the protective layer. Alternatively, the plurality of electrons are provided by a process selected from corona discharge, electron beam injection, ion-beam implantation, contact electrification, thermal charging, radiative and photoelectret processes, and triboelectric charging. The floating conductive layer interacts with charged particles to facilitate a uniform spatial distribution of charge along the electrically floating conducting region.

FIG. 14 illustrates a side-view diagram of an electret material of the method provided by the above Figures. This diagram is merely an example, which should not unduly limit the scope of the claims herein. One of ordinary skill in the art would recognize many variations, modifications, and alternatives. As shown, the device has a thickness of substrate material having a contact region. An electrically floating conducting region is formed overlying the thickness of substrate material. The floating conducting region is free from physical contact with the contact region. A protective layer is formed overlying the floating conductive layer. The protective layer has a surface region and seals the floating conducting region. The thickness of substrate material, floating conducting region, and protective layer form a sandwiched structure having a charge density of at least 1×10⁻⁴ Coulombs/m² and a peak to peak charge uniformity of 5% and less. As further shown, the floating conductive layer includes edges that have been sealed using the overlying protective layer.

Although the above method is illustrated using a selected sequence of steps, it would be recognized that various modifications, alternatives, and variations exist. For example, some of the steps may be combined. Alternatively, some of the steps may be separated. Additional steps may be added before, within, or after any of the steps described above. The method can also provide the sequence of steps in a different manner without departing from the scope of the claims herein. Further ways of performing a method of fabricating an electret material can be found throughout the present specification and more particularly below.

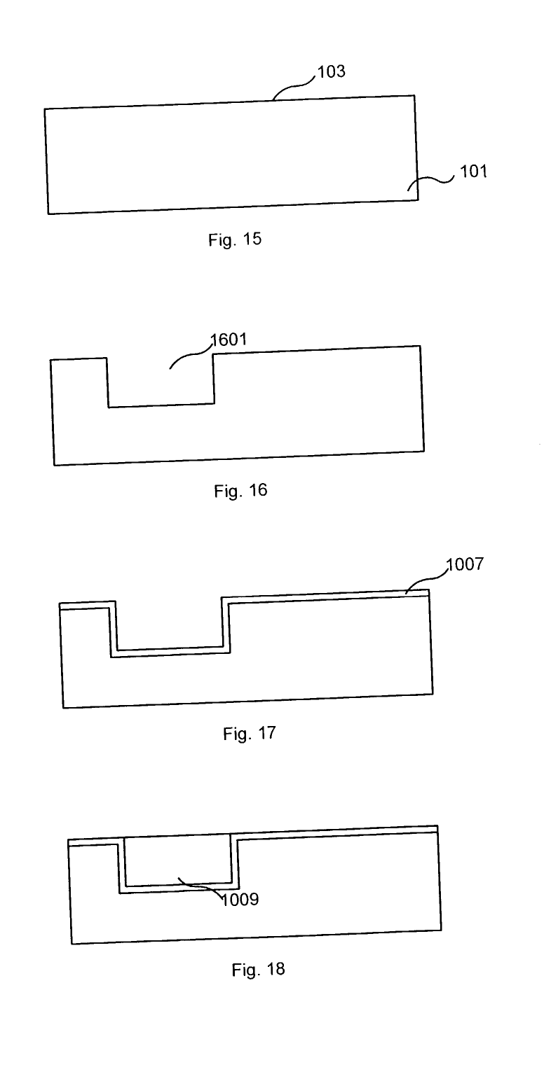

FIGS. 15-21 are simplified diagrams of an alternative method of forming an electret material according to an alternative embodiment of the present invention. These diagrams are merely examples, which should not unduly limit the scope of the claims herein. One of ordinary skill in the art would recognize many variations, modifications, and alternatives. Like reference numerals are used in these diagrams as the others, but are not intended to be limiting the scope of the claims herein. As shown, the method begins by providing a substrate 101. The substrate includes an overlying surface 103, which is preferably planar and smooth. The substrate is selected from a suitable material. The material can include silicon as well as glass or quartz. Preferably, the substrate comprises a silicon bearing material. Here, the substrate can be made of a silicon wafer. The silicon wafer can be doped or undoped. The silicon wafer can have a <100> orientation, but also can have other orientations. Depending upon the application, the substrate can also be conductive or insulating. The substrate can be made of a single homogeneous material, a graduated material, or multilayered material such as SOI, depending upon the application.

Referring to FIG. 16, the method patterns the substrate. The patterned substrate includes a recessed region 1601. The recessed region has a depth of about 40 micron. In a specific embodiment, the recessed region has an aspect ratio of about 0.4 and less. The substrate is patterned using conventional photolithography and etching techniques. For example, a hard mask is provided using silicon dioxide, nitride, or a combination of these materials. A photolithography process can also be used depending upon the application. Etching techniques such as reactive ion etching form the recessed region. Furthermore, the recessed regions can be made using an injection molding, hot embossing, die cast, and other processes in a wide range of materials such as metals, plastics, liquid metals, any combination of these, and the like. Forming electrets in cavities allows easy creation of thick dielectric layers in certain embodiments.

The method includes forming a conductive layer 1007 overlying the substrate, as shown in FIG. 17. The conductive layer can be made of a suitable material such as aluminum, aluminum alloy, conductive polymer, gold, platinum, titanium, titanium alloy, tungsten, any combination of these and the like. The conductive layer can also be formed using multiple layers, which are stacked together to form a sandwiched structure. Aluminum is often sputtered overlying the surface of the substrate material. The conductive layer can form a portion of the contact region, which will be further described below.

The method includes forming an insulating layer 1009 overlying the conductive layer, as shown in FIG. 18. The insulating material can be made of a suitable material such as silicon dioxide, polystyrene, and similar materials. Voids, or gaps filled with gasses or air may also be included in the insulating material. Preferably, the insulating layer comprises a material such as fluoropolymer bearing material, which is a product sold by E. I. Du pont de Nemours and Company (herein “Dupont”) under the trademark Teflon®. The insulating material can be a single layer or multiple layers depending upon the application. Preferably, the insulating layer is formed within the recessed region and has a planarized surface that is even with the surface of the substrate according to a specific embodiment.

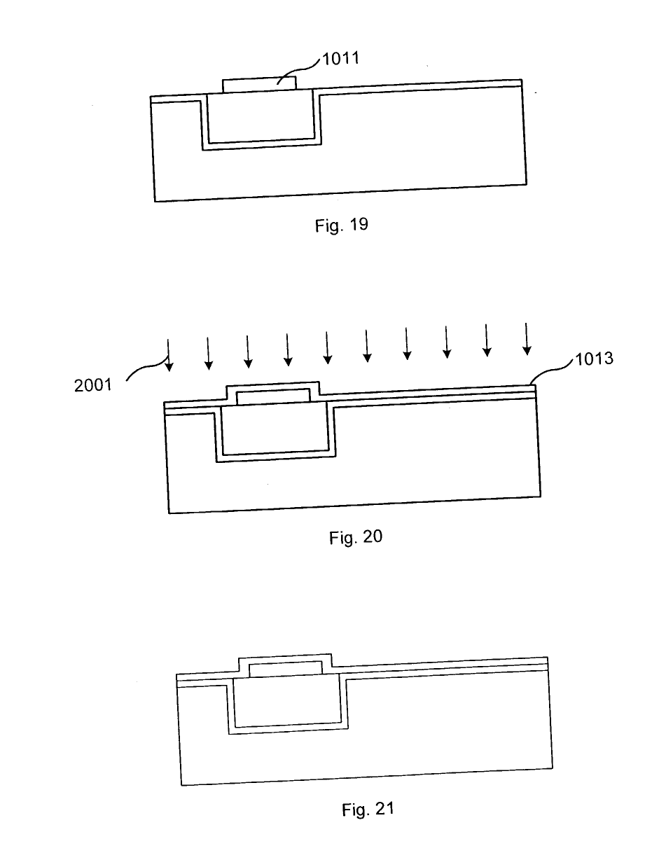

Next, the method forms an electrically floating conducting region 1011 overlying the insulating layer, as shown in FIG. 19. The floating conducting region is free from physical contact with the contact region, which is on the conductive layer, via the insulating layer. The conducting region is made of a suitable material such as aluminum, gold, platinum, titanium, tungsten, alloys of such materials, or the like. Preferably, the floating conductive layer is aluminum that has a thickness of 5000 Angstroms and less.

As shown, the floating conductive layer has been patterned using lithographic techniques. Preferably, the method forms an overlying layer of photoresist material overlying the floating conductive layer. The photoresist material is patterned using conventional lithographic techniques to form a patterned mask structure. Etching techniques within openings of the patterned mask structure form the patterned floating conductive layer. The floating conductive layer includes a length that does not extend beyond the underlying insulating material, as also shown. Also shown are edges on the floating conductive layer. The edges are formed within the region occupied by the insulating layer to isolate the floating conductive layer from the underlying conductive layer. The edges of the floating conductive layer are also within the recessed region.

The method also includes forming a protective layer 1013 overlying the floating conductive layer, as shown in FIG. 20. The protective layer has a surface region. The protective layer seals the floating conducting region, including its edges. The protective layer can be made of a suitable material that seals the floating conductive layer. The protective layer can include sputtered oxide, a plasma deposited fluoro polymer, SOG (“Spin-On-Glass”), polystyrene, and other deposited fluoropolymers. The protective layer can be a single layer or multiple layers, depending upon the application.

Charge particles 2001 implant into a sandwiched structure, as shown in FIG. 20. The thickness of substrate material, floating conducting region, and protective layer forms the sandwiched structure having an initial charge density of at least 1×10⁻⁴ Coulombs/m² and a peak to peak charge uniformity of 5% and less. Preferably, the charge density is provided by implantation of a plurality of electrons, which are introduced through the protective layer. Alternatively, the plurality of electrons are provided by a process selected from corona discharge, electron beam injection, ion-beam implantation, contact electrification, thermal charging, radiative and photoelectret processes, and triboelectric charging. The floating conductive layer interacts with charged particles to facilitate a uniform spatial distribution of charge along the electrically floating conducting region.

FIG. 21 illustrates a side-view diagram of an electret material of the method provided by the Figures. This diagram is merely an example, which should not unduly limit the scope of the claims herein. One of ordinary skill in the art would recognize many variations, modifications, and alternatives. As shown, the device has a thickness of substrate material having a recessed region. An insulating material is formed within the recessed region. Preferably, a conducting region is also formed underlying the insulating material within the recessed region. An electrically floating conducting region is formed overlying the insulating layer. The floating conducting region is preferably patterned and free from physical contact with the conducting region. A protective layer is formed overlying the floating conductive layer. The protective layer has a surface region and seals the floating conducting region. The thickness of substrate material, floating conducting region, and protective layer form a sandwiched structure having a charge density of at least 1×10⁻⁴ Coulombs/m² and a peak to peak charge uniformity of 5% and less. As further shown, the floating conductive layer includes edges that have been sealed using the overlying protective layer.

Although the above method is illustrated using a selected sequence of steps, it would be recognized that various modifications, alternatives, and variations exist. For example, some of the steps may be combined. Alternatively, some of the steps may be separated. Additional steps may be added before, within, or after any of the steps described above. The method can also provide the sequence of steps in a different manner without departing from the scope of the claims herein. For example, although a metal layer has been used to form a region associated with charge accumulation, other types of surfaces can be used including dielectric and/or semiconductor regions that can trap charges for one reason or another. Additionally, the specific location of the electric charge can vary depending upon the embodiment. Certain charge can be within the metal layer or underlying the metal layer or overlying the metal layer or any combination of these without departing from the scope of the claims herein. Further ways of performing a method of fabricating an electret material can be found throughout the present specification and more particularly below.

Experiments:

To prove the principle and operation of the present invention, we performed experiments. These experiments are merely examples, and should not limit the scope of the claims herein. One of ordinary skill in the art would recognize many variations, alternatives, and modifications. Such experiments used a micromachined rotational electret power generator, linearized theoretical model of electret power generation. The electret power generator was made using electret materials, such as those noted above, but can be others. Additionally, we provided a method to produce uniformly charged electret.

As noted in the background, electret generators generally differ from electromagnetic generators in that the electromotive force is purely electric. Electret generator theory and experiment was reported by O. D. Jefimenko, IEEE Trans. Ind. Appl., Vol. IA-14, pp. 537-540, 1978, and by Y. Tada, IEEE trans. Elect. Insul. EI-21, 1986, pp. 457-464. An electret generator with a radius of 45 mm was studied by Y. Tada, Jpn. J. Appl. Phys., Vol. 31, Part 1, No. 3, 1992, pp. 846-851. A maximum reported power output from an electret generator was 1.02 mW. We discovered that miniaturizing this technology included use of micromachining and a compatible electret technology, which achieved power generation greater than 1 mW.

As an electret, the Teflon® material can contain charge densities of −5×10⁻⁴ C/m² with theoretical lifetimes of hundreds of years J. A. Malecki, Phys. Rev. B. Vol. 59, no. 15, 1999, pp. 9954-9960. We used Teflon AF 1601-S because it is a spin-on dielectric compatible with MEMS processes. We extended our processing capabilities to allow for multiple spins of this material and also patterning using photoresist. Electrons can then be quickly implanted utilizing a back lighted thyratron (BLT) T. Y. Hsu, “A Novel Electron Beam Source Based on the Back-Lighted Thyratron”, Ph.D. dissertation, Univ. Southern California, 1992, also called a psuedospark device in literature K. Frank, E. Dewald, C. Bickes, U. Ernst, M. Iberler, J. Meier, U. Prucker, A. Rainer, M. Schlaug, J. Schwab, J. Urban, W. Weisser, and D. H. H. Hoffmann, IEEE trans. on Plasma Science, Vol. 27, No. 4, 1999, pp. 1008-1020. Further details of our design and fabrication processes according to the present experiments are provided below.

Rotors were made with a radius of 4 mm and stators with a radius of 5 mm. Design size was chosen to achieve an available area on a 1 cm² chip to avoid having to stitch more than one exposures on the stepper. The rotor is 4 mm in radius so that surface contact to the ground layer of the stator is possible with silver paste. Since only regions where the rotor and stator overlap result in the production of electricity, for all practical purposes, r_{eff}=4 mm is used.

The number of poles in our experiments, n=4, were chosen to compare with results found in literature. In Tada's work, the number of poles remains low due to the method of making them, namely cutting by hand MEMS lithography is capable of producing lines smaller than 10 μm, which far exceeds the assumptions that fringing fields can be neglected.

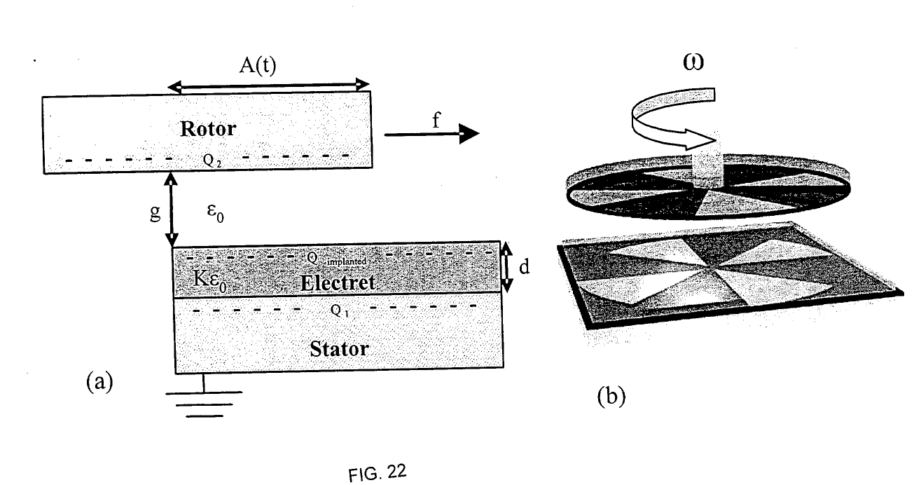

Teflon thickness for the generator was 9 μm, and, in contrast to Tada's setup, was on the stator. This configuration was chosen for the ability to try many different thicknesses without having to remount the rotor. The rotor must be mounted with plane normal aligned to the long axis of the axle or else the planes of the rotor and stator cannot be parallel during rotation. The dimensions can be easily seen in FIG. 22. Further details of a process flow for manufacturing the electret material are provided below.

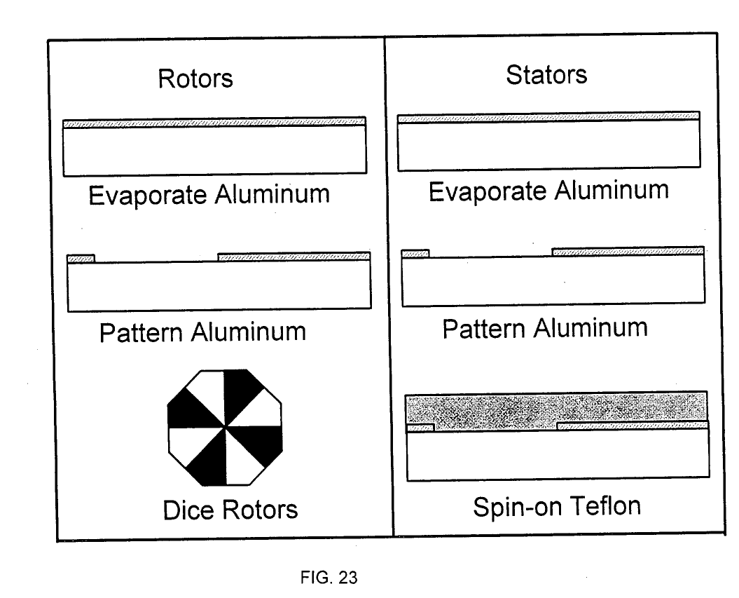

FIG. 23 shows an example of the process flow of a rotor and stator with dielectric. Rotors and stators for electret generators should have a matching number of poles. For the rotor, 2000 Å aluminum was evaporated onto a quartz wafer and then patterned. The wafer was then diced, and one die was diced into an octagonal shape to closer approximate a circular rotor. Stators are produced by first evaporating 2000 Å aluminum onto a quartz wafer. The aluminum layer is patterned and then a thick layer of Teflon AF 1601-S is spun on. In previous processing, it was determined that a 1.2 μm Teflon layer can be spun-on if the Teflon solution is 6% solids and 94% Fluorinert FC-75, as supplied by Dupont. This thin film initially has a rough surface and after a long prebake at 330° C. for 15 minutes to allow the surface to reflow. Baking at this temperature also has the added effect of removing all solvent, which is a necessary step when spinning multiple layers of Teflon.

Dupont also supplies an 18% solids version of the Teflon AF, but this solution is too viscous for conventional spinning. We made a 7.4% solids mixture by mixing the 18% solids version of Teflon with Fluorinert FC-40. This solution produces spun-on films 9 μm thick at 500RPM. Fluorinert FC-40 has similar electrical characteristics to Fluorinert FC-75, but FC-40 has a kinematic viscosity 2.75 times higher than FC-75. Furthermore, the 1.2 μm film had height fluctuations greater than 25% while the 91 μm film had variations less than 1%. The main disadvantage of FC-40 is its higher boiling point, which means higher temperatures and longer bake times are required to drive off all solvent from the thicker film Teflon film.

Applying HMDS vapor for 3 minutes to the fully baked, spun-on Teflon modified its naturally hydrophobic nature enough for photoresist to be spun on top of the Teflon. Further trials also proved that spinning Teflon on fully baked Teflon is also possible with use of HMDS. The adhesion between Teflon layers appears to be very good, and often was better than adhesion between thermally evaporated aluminum and the substrate. In the case of a floating metal layer, adhesion between the aluminum that was evaporated on top of Teflon is sufficient unless the any part of the Teflon-aluminum interface is exposed to solvents. Thus, floating metal layers must be sealed before wet dicing or other wet etch steps occur.

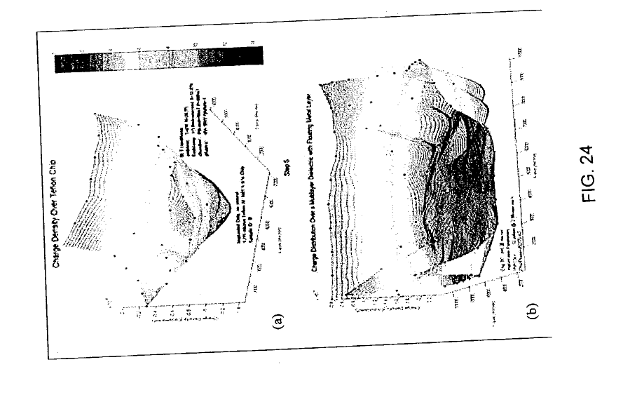

Electron beam implantation is a well-studied method for implanting electrons within dielectrics. Beam writing can be performed by raster scanning over a dielectric; it takes considerable of time to implant a sufficient number of electrons while occupying an expensive machine for a menial task using this method. In contrast, a BLT provides a pulsed electron source with very large electron doses within ˜100 ns. Implantation with the BLT produces a Gaussian distribution over the surface of the electret, as in FIG. 24(a), which is not desirable for providing a uniform electret. To alleviate this problem, a metal layer is deposited on top of a thick dielectric layer, patterned to be electrically floating Patent pending, and then sealed with a thin dielectric layer. The floating metal layer provides a reference voltage and therefore an electric field non-uniformity of less than 1% of the surface as seen in FIG. 24(b). As further described in FIG. 24, we illustrated (a) Charge density of implanted Teflon using the back lighted thyratron (b) charge implanted in a chip with floating metal layer patterned into a circle, charge outside the metal circle is approximately equal to the Gaussian case.

We measured charge densities with a Monroe Electronics isoprobe Model 244 with a high resolution 1024AEH probe. We mounted the probe on an x-y-z stage to allow precise measurements of the effective surface charge. Minimum observed resolution in x and in y was 244 μm, although the resolution of the stage was 25.4 μm in x-axis and 10 μm in the y-axis. The electret generator relies on an electric field that is fixed in z but variable in x-y, and therefore effective surface charge densities in x-y defined by only the dielectric thickness and the voltage of the surface measured with the isoprobe is sufficient for quantifying the charge

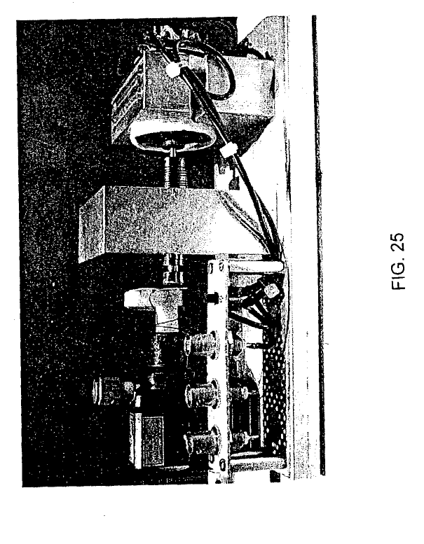

After fabrication of the rotor and stator it is necessary to mount them to an apparatus that can supply rotation. We built a testbed for this purpose (FIG. 25) with an angular misalignment of 0.46 degrees for the rotor, which was measured by shining a laser pointer at the spinning rotor and measuring the radius of the reflected circle and the baseline distance.

A 5-axis micropositioner is used for aligning the stator to the rotor. In trying to minimize the gap spacing, the stator is lightly crashed into the rotor at one point, but because of angular misalignment the far end of the rotor is at least 80 μm away from the stator.

Power generation experiments using the testbed involves setting the gap distance, driving the motor at different speeds, and simultaneous measurement of speed and power output. The ground lead of the generator is the ground of the stator and the power lead is the chassis of the test bed which is electrically connected to the rotor through a bearing. The power lead is connected to a simple op-amp, National Semiconductor LF356, in a voltage follower configuration with 1012 Ohm input impedance. This high impedance allows load matching by placing different load resistors across the power and ground. Power output is measured by two different means: (a) voltage output from the amplifier is fed to an HP 54503A 500 MHz Digitizing Oscilloscope to observe the waveform or (b) voltage output from the amplifier is measured in VRMS with a Fluke 87III True RMS handheld multimeter. Power from the generator is simply VRMS2/RL.

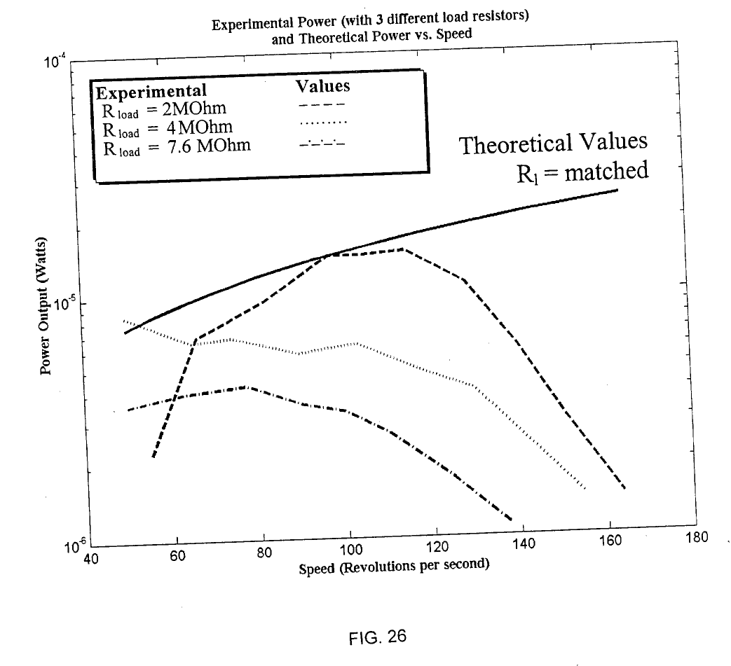

Several methods of measuring the speed were employed to check for accuracy. A stroboscopic tachometer showed some drift from other measurement techniques, so the output waveform from the 4-pole generator was used directly by measuring n=4 periods of the output signal. The motor is a 6-pole motor, and confirmation of speed measurements was made by connecting a secondary channel of the oscilloscope across the terminals of the motor and verifying that 6 periods of back-emf of the motor corresponded to 4 periods of the generator. Additionally, the Fluke handheld multimeter has an option to measure the frequency of an ac signal, which, as expected, was exactly 4 times larger than the frequency acquired from the other methods. The oscilloscope was the primary source of speed measurements. Pulse width modulation was not a viable option to control speed since the motor used draws a current up to 30A. Here, we illustrated in FIG. 26 theoretical values of a continuously load matched system and power output from 3 experimental trials using different load resistances.

Assuming the width of the electrodes is large compared to the distance between them, a linearized theory is derived by assuming that an electret generator acts as a fixed-charge, variable capacitance device. FIG. 22 explains the geometry used in the derivation.

Conservation of charge implies

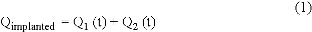

Charge on capacitor is related to the area of the overlapping capacitors.

$${C}_{1} ( t ) = \frac{{K}_{teflon} {ϵ}_{0}}{d} A ( t ) \\ {C}_{2} ( t ) = \frac{{ϵ}_{0}}{g} A ( t ) \qquad ( 2 )$$

The equation describing the equivalent circuit is

$$\begin{matrix}V ( t ) = \frac{- {Q}_{1} ( t )}{{C}_{1} ( t )} + \frac{{Q}_{2} ( t )}{{C}_{2} ( t )} \\ = ( \frac{- d}{{K}_{teflon} {ϵ}_{0}} ) \frac{Q}{A} + ( \frac{d}{{K}_{teflon} {ϵ}_{0}} + \frac{g}{{ϵ}_{0}} ) \frac{{Q}_{2} ( t )}{A ( t )}\end{matrix} \qquad ( 3 )$$

Where K_{telflon} is the dielectric constant of Teflon AF 1601 listed as 1.93. Since

$$\begin{matrix}V ( t ) = I R = - \frac{\partial {Q}_{2} ( t )}{\partial t} R \\ I ( t ) = \frac{σ d}{{K}_{teflon} {ϵ}_{0} R} - ( \frac{d}{{K}_{teflon} {ϵ}_{0}} + \frac{g}{{ϵ}_{0}} ) \frac{{Q}_{2} ( t )}{A ( t ) R}\end{matrix} \qquad ( 4 )$$

For a rotational geometry neglecting fringing fields,

$$\begin{matrix} A ( t ) = \{ \begin{matrix}\frac{n π {r}^{2} f}{2} t & for t : 0 < t < \frac{1}{2 n f} & \\ - \frac{n π {r}^{2} f}{2} t & for t : \frac{1}{2 n f} < t < \frac{1}{n f} & \end{matrix} \\ Let α = ( \frac{d}{{K}_{teflon} {ϵ}_{0}} + \frac{g}{{ϵ}_{0}} ) \frac{1}{n π {r}^{2} f R} and \\ β = \frac{σ d}{{K}_{teflon} {ϵ}_{0} R} & ( 5 ) \\ Then {Q}_{2} ( t ) = \frac{β t}{1 + α} - {Ct}^{- α} & ( 6 )\end{matrix}$$

With capacitor plates completely out of phase at t=0, Q₂(0)=0

$$I ( t ) = \frac{- σ \frac{d}{{ϵ}_{0}}}{R + \frac{1}{n π {r}^{2} f} ( \frac{d}{{K}_{teflon} {ϵ}_{0}} + \frac{g}{{ϵ}_{0}} )} \qquad ( 7 )$$

Maximum power is achieved when

$${R}_{optimal} = \frac{1}{n π {r}^{2} f} ( \frac{d}{{K}_{teflon} {ϵ}_{0}} + \frac{g}{{ϵ}_{0}} ) \qquad ( 8 )$$

This gives a load-matched power equation

$${P}_{optimal} = \frac{{σ}^{2} n π {r}^{2} f}{\frac{4 {K}_{teflon} {ϵ}_{0}}{d} ( 1 + \frac{{K}_{teflon} g}{d} )} \qquad ( 9 )$$

Charge density is limited by the dielectric strength of the material. In the case of Teflon AF 1601-S, this value is 20V/μm. Power output increases with decreasing dielectric constant, which is why Teflon AF with dielectric constant of 1.93 is chosen.

Gap spacing (g) should be minimized but spacing smaller than ¼ of the dielectric thickness is sufficiently small. Therefore, gap spacing is directly related to the thickness of the electret. The thickness of the electret is limited by processing issues for Teflon AF, but if this were not the case then the limiting thickness is related to the breakdown voltage in air.

Power generation experiments were performed and the results are shown in FIG. 26. The experimental curve shown is a load matched curve (Equation 9) and uses a gap spacing of 60 μm. This is very reasonable considering that the minimum spacing is zero at the crashed edge and 80 μm at the far edge. The other parameters used in the theoretical values match the measured values of the generator, which are n=4, r=4 mm, σ=−2.8×10−4 Coulomb/m^{2,} KTeflon=1.93, d=9 μm. The noise in the experimental graphs are exactly because the stator was crashed into the rotor. This was necessary to know the gap spacing exactly. The generator continues to perform well under this condition, despite some wear to the surfaces.

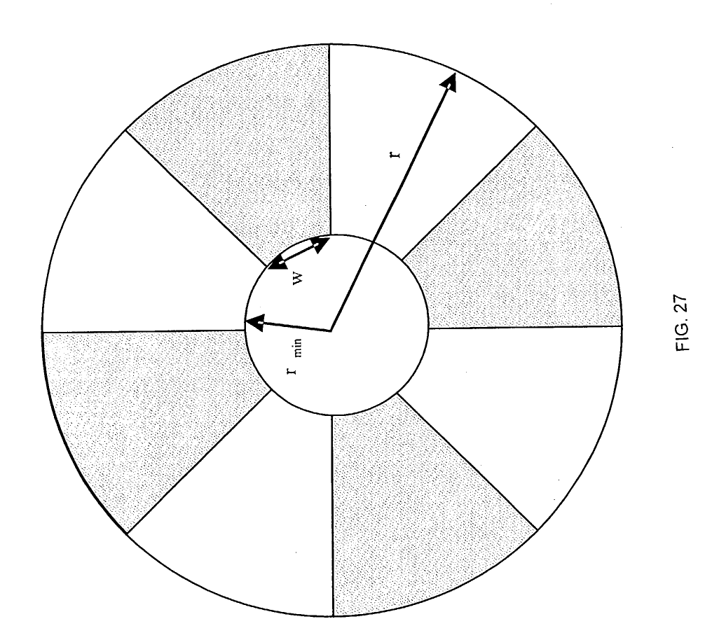

To verify that neglecting the flinging field is a valid assumption, we say that the smallest dimension within 90% of the active generator area must be ten times larger than the gap distance. Since 90% of the effective area of an r=5 mm generator is outside r=1.58 mm, the shortest dimension w (see FIG. 27) is found to be 1.2 mm by using the number of poles and the law of cosines. Assuming w must be ten times larger than g and we previously stated that a decent g is preferably ¼ d, we determined that w need only be 22.5 μm for a 9 μm dielectric thickness. The condition is more than met in our experiments, and by using this argument we expect to see good performance in generators with a few hundred poles.

Uniform charge density, gap control, and dielectric thickness are the primary challenges of designing and producing an electret generator. We engineered solutions to provide uniform charge density on thick, micromachine-compatible dielectric. We derived a linearized theory that adequately models experimental power measurements. Future work will focus on gap spacing, increasing the number of poles, elimination of rotor tilt, and verifying the charge distribution in the z-axis on charge implanted into a floating metal electret. We have already begun work on a testbed-less electret generator that overcomes the aforementioned difficulties by relying more heavily on the advantages of micromachining.

The above example is merely an illustration, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of fabricating an electret device, the method comprising:
providing a thickness of substrate material having a contact region;
forming an electrically floating conducting region formed overlying the thickness of substrate material, the floating conducting region being free from physical contact with the contact region;
forming a protective layer formed overlying the floating conductive layer, the protective layer having a surface region, the protective layer sealing the floating conducting region;
whereupon the thickness of substrate material, floating conducting region, and protective layer form a sandwiched structure having an initial charge density of at least 1×10⁻⁴ Coulombs/m² and a peak to peak charge uniformity of 5% and less.

2. The method of claim 1 wherein the forming of the floating conducting region comprises patterning using at least a micromachining process.

3. The method of claim 1 wherein the thickness of substrate material is a Teflon material having a thickness of about 100 microns and less; wherein the floating conducting region comprises an aluminum bearing material having a thickness of 5000 Angstroms and less.

4. The method of claim 1 wherein the thickness of substrate material comprises Teflon.

5. The method of claim 1 wherein the floating conducting region comprises an aluminum bearing material or an aluminum alloy bearing material.

6. The method of claim 1 wherein the protective layer is Teflon.

7. The method of claim 1 wherein the floating conducting region is a single layer or multiple layers.

8. The method of claim 1 wherein the protective layer is sputtered oxide, a plasma deposited fluoro-polymer, SOG (“Spin-On-Glass”).

9. The method of claim 1 wherein the protective layer has a resistivity of greater than a predetermined amount.

10. The method of claim 1 wherein the floating conductive layer has a conductivity is at least a predetermined amount.

11. The method of claim 1 wherein the conductive layer has a resistivity value less than a resistivity value of the protective layer.

12. The method of claim 1 wherein the charge density is provided by implantation of a plurality of electrons.

13. The method of claim 1 wherein the plurality of electrons are provided by a process selected from corona discharge, electron beam injection ion-beam implantation, contact electrification, thermal charging, radiative and photoelectret processes, and triboelectric charging, and e-beam.

14. The method of claim 1 wherein the substrate is provided via spinning liquid Teflon.

15. The method of claim 1 wherein the substrate is provided via compression molding.

16. The method of claim 1 substrate is selected from chemical vapor deposition, plasma enhanced vapor deposition, electrospray, and aerosol deposition.

17. The method of claim 1 wherein the substrate is provided on a mounting substrate to hold the substrate in place.

18. The method of claim 17 wherein the mounting substrate comprises an overlying metal layer, the metal layer coupled to the substrate.

19. The method of claim 1 wherein the substrate is made using damascene process.

20. The method of claim 1 wherein A method of fabricating an electret device, the method comprising:
providing a thickness of substrate material having a contact region;
forming an electrically floating conducting region formed overlying the thickness of substrate material, the floating conducting region being free from physical contact with the contact region;
forming a protective layer formed overlying the floating conductive layer, the protective layer having a surface region, the protective layer sealing the floating conducting region;
whereupon the thickness of substrate material, floating conducting region, and protective layer form a sandwiched structure having an initial charge density of at least 1×10⁻⁴ Coulombs/m² and a peak to peak charge uniformity of 5% and less;
whereupon the floating conductive layer interacts with charge charged particles to facilitate the a uniform spatial distribution of charge along the electrically floating conducting region.

21. The method of claim 20 wherein the charged particles are is provided via implantation of a plurality of particles.

22. An electret device comprising:
a thickness of substrate material having a contact region;
a floating conducting region formed overlying the thickness of substrate material, the floating conducting region being free from physical contact with the contact region;
a protective layer formed overlying the floating conductive layer, the protective layer having a surface region, the surface region being free from physical contact with the floating conducting region;
whereupon the thickness of substrate material, floating conducting region, and protective layer form a sandwiched structure having a charge density of at least 1×10−4 Coulombs/m² and a peak to peak charge uniformity of 5% and less.

23. The device of claim 22 wherein the floating conducting region is patterned using at least a micromachining process.

24. The device of claim 22 wherein the thickness of substrate material is a Teflon material having a thickness of about 40 microns and less; wherein the floating conducting region comprises an aluminum bearing material having a thickness of 5000 Angstroms and less.

25. The device of claim 22 wherein the thickness of substrate material comprises Teflon.

26. The device of claim 22 wherein the floating conducting region comprises an aluminum bearing material or an aluminum alloy bearing material.

27. The device of claim 22 wherein the protective layer is Teflon.

28. The device of claim 22 wherein the floating conducting region is a single layer or multiple layers.

29. The device of claim 22 wherein the protective layer is sputtered oxide, a plasma deposited fluoro-polymer, or SOG.

30. The device of claim 22 wherein the protective layer has a resistivity of greater than a predetermined amount.

31. The device of claim 22 wherein the floating conductive layer has a conductivity is at least a predetermined amount.

32. The device of claim 22 wherein the conductive layer has a resistivity value less than a resistivity value of the protective layer.

33. The device of claim 22 wherein the charge density being measured via a voltage potential.

34. The device of claim 22 wherein the charge density is provided by implantation of a plurality of electrons.

35. The device of claim 22 wherein the plurality of electrons are provided by a e-beam.

36. The device of claim 22 wherein the substrate is provided via spinning liquid Teflon.

37. The device of claim 22 wherein the substrate is provided via compression molding.

38. The device of claim 22 substrate is selected from silicon, glass, and plastic.

39. The device of claim 22 wherein the substrate is provided on a mounting substrate to hold the substrate in place.

40. The device of claim 39 wherein the mounting substrate comprises an overlying metal layer, the metal layer coupled to the substrate.

41. The device of claim 22 wherein the substrate is made using damascene process.

42. The device of claim 22 wherein floating conductive layer interacts with charge to facilitate the uniform distribution of charge.

43. The device of claim 42 wherein the charge is provided via implantation of a plurality of particles.
